(19) United States
(12) Patent Application Publication
(10) Pub. No.: US 2023/0227151 A1
(43) Pub. Date: Jul. 20, 2023

(54) A METHOD

(71) Applicants: L-UNIVERSITA TA MALTA, Msida (MT); QUAERO LTD., Mosta (MT)

(72) Inventors: Jason GAUCI, Rabat (MT); Marlon GALEA, Gozo (MT); Alan MUSCAT, Pembroke (MT); Ian THORNTON, Naxxar (MT); David Zammit MANGION, Mellieha (MT)

(21) Appl. No.: 18/011,625

(22) PCT Filed: Apr. 27, 2021
(86) PCT No.: PCT/EP2021/061003

§ 371 Date: Dec. 20, 2022

(30) Foreign Application Priority Data
Jun. 22, 2020 (GB) 2009466.0

(51) Int. Cl. B64C 25/50; B64C 13/04; G05D 1/02

(52) U.S. Cl. CPC B64C 25/50; B64C 13/042; G05D 1/0202

(57) ABSTRACT

A method for controlling an aircraft when taxiing comprising the steps of: measuring an angle of rotation of an active side stick about a first axis and a second axis; receiving an aircraft signal representative of an actual state of the aircraft; generating a control signal based on at least one of: the aircraft signal and the angle of rotation of the active side stick about a first axis and a second axis; transmitting the control signal to the aircraft, whereby the control signal causes an action affecting the actual state of the aircraft; determining a required state of the aircraft; generating a user feedback signal based on at least one difference between the actual state and the required state; and carrying out a user feedback action based on the user feedback signal.

This invention relates to a method for controlling an aircraft when taxiing. In particular the invention relates to a method which allows a controller of an aircraft to control an aircraft when taxiing, that is before take-off and after landing, with a single control device rather than with a combination of control devices. From here on in, a controller of an aircraft may be referred to generally as a pilot.

In current taxi operations of large commercial aircraft pilots are required to use multiple controls including a tiller to steer the nose wheel of the aircraft, two or more throttle levers (depending on the number of engines) that may be adjusted together to control straight-line speed and independently to provide differential thrust, and a pair of brake pedals that may be adjusted together to reduce overall speed and independently provide differential braking.

The number of different controls that must be managed simultaneously while taxiing results in taxi operations being complex which in turn increases the likelihood of errors occurring.

Today aircraft are primarily controlled by a yoke (also referred to as a control column or control wheel) or a side stick (also referred to as a side stick controller) for pitch and roll control during flight (i.e. not when taxiing). In the case of aircrafts which are equipped with a side stick (such as the Airbus family of aircraft), the side stick is ‘passive’. This means that the operator can feel the dynamics of the side stick itself and cannot feel the dynamics of the controlled system (i.e. the aircraft dynamics). Therefore, the operator has to estimate the aircraft's behaviour to keep it within safety limits. The feel characteristics of a passive side stick are controlled by springs, dampers, etc. to produce a certain force-displacement characteristic. For example, the resistance to deflection may be increased the further that the side stick is deflected from a neutral position.

According to an aspect of the invention there is provided a method for controlling an aircraft when taxiing comprising the steps of:
measuring an angle of rotation of an active side stick about a first axis and a second axis;
receiving an aircraft signal representative of an actual state of the aircraft;
generating a control signal based on at least one of: the aircraft signal and the angle of rotation of the active side stick about a first axis and a second axis;
transmitting the control signal to the aircraft, whereby the control signal causes an action affecting the actual state of the aircraft;
determining a required state of the aircraft;
generating a user feedback signal based on at least one difference between the actual state and the required state; and
carrying out a user feedback action based on the user feedback signal.

By means of the invention a pilot may control an aircraft when taxiing by manipulating a side stick in order to rotate it about the first and second axes (which may be equivalent to a pitch axis and a roll axis respectively). In very general terms, forward deflection of the side stick about the first axis may correspond to a throttle or acceleration command, backward deflection about the first axis may correspond to a braking or deceleration command and left and right deflection about the second axis may correspond to a steering command. The angle of rotation of the side stick is measured and may be compared against an actual state of the aircraft in order for a control signal to be generated and transmitted to the aircraft. In other words, the command issued by the pilot via deflection of the side stick is translated to a command that may be received by the aircraft and then performed, for example via adjustment of throttle and brake levers. In some embodiments of the invention the force applied by the pilot in deflecting the side stick may also be measured and the generated control signal may be based, at least in part, on the measured deflection force.

Simultaneously to the pilot being able to issue a control command to the aircraft via the side stick, feedback may be issued to the pilot which indicates the status of the aircraft. The feedback is provided in the form of a user feedback action performed by the side stick; hence the side stick is an active side stick. The user feedback action may be any suitable action to be performed by the active side stick which indicates to the pilot a difference between an actual state of the aircraft and a required state of the aircraft. For example, the user feedback action may be an increase in resistance to deflection of the active side stick, a force applied by the active side stick in a direction opposite to the pressure being applied by the pilot or a vibration of the active side stick.

In such embodiments of the invention each step may be performed continuously and in parallel with one another such that the angle of rotation of the active side stick about the first and second axes is constantly being measured and the control signal is constantly being updated based on the current angle measurement. Similarly, an aircraft signal comprising an actual state of the aircraft may continuously be received and translated to a user feedback action to be carried out by the active side stick. Accordingly the pilot may control the aircraft and receive feedback on the actual state of the aircraft in real time.

Further, the aircraft signal may comprise a plurality of actual states of the aircraft, such as position on the taxiway relative to the taxiway centreline, actual ground speed, acceleration and nose wheel steering angle.

Also, in such embodiments of the invention, the pilot may issue all control commands that may typically be required when taxiing an aircraft via a single control instrument, the active side stick. Hence the pilot's method of controlling the aircraft while taxing may be simplified in comparison to known control methods which require simultaneous manipulation of multiple control instruments such as tillers, throttle levers and brake pedals.

Further, the pilot may receive feedback on the status of the aircraft via the active side stick. This may be advantageous over equivalent control methods to control an aircraft when taxiing that involve a passive side stick. Although a passive side stick may allow the number of controls to be reduced, the pilot would still be required to estimate the aircraft's behaviour on the taxiway in order to ensure that the aircraft is maintained within safety limits. Therefore there would still be a high level of complexity involved with using a passive side stick to control an aircraft while taxiing. However, the provision of feedback to the pilot, via the active side stick, indicative of the aircraft's behaviour may substantially reduce the degree of estimation required. Accordingly the room for human error and risk to the aircraft and its passengers may also be reduced.

The active side stick may also be multi-functional in that it can be used during taxiing and during flight. For example, when the aircraft is in the air the active side stick may provide feedback to the pilot which reflects the aircraft's dynamics.

In embodiments of the invention the user feedback signal is generated such that the magnitude of the user feedback action is proportional to a difference between the actual state and the required state.

In such embodiments of the invention the magnitude of the user feedback action carried out by the active side stick may give a more precise indication of the difference between the actual state and the required state. For example, the user feedback action may be a vibration, the magnitude (intensity) or frequency of which increases proportionally to the difference between the actual state and the required state. In another example where a reduction of the difference between the actual state and the required state is preferable, the user feedback action may be a force bias of the active side stick towards an angle of rotation about the second axis that would cause the difference between the actual state and the required state to reduce. In this example the magnitude of the force bias, i.e. the force with which the active side stick is driven to the correct angle, may be proportional to the difference between the actual state and the required state. In such an example, the force with which the active side stick is driven may be limited so that the pilot is fully capable of overriding the bias, thereby ensuring that the pilot has ultimate control authority. A similar form of user feedback may also be advantageous if the active side stick is used during flight wherein the feedback action may be equivalent to an autopilot feature.

In embodiments of the invention a difference between the actual state and the required state is a cross-track error representative of the shortest distance between an aircraft position on a taxiway and a centreline of the taxiway. The aircraft position may be based on the position of the nose wheel landing gear.

In such embodiments of the invention, the pilot may receive feedback via the active side stick that indicates if the aircraft is straying from the centreline of the taxiway and is therefore in danger of leaving the taxiway. If an aircraft leaves the taxiway it is possible that the landing gear (or undercarriage) of the aircraft may be damaged, particularly if the aircraft is a large commercial aircraft.

The best way for the pilot to ensure that an aircraft sticks to the taxiway is by keeping the aircraft as close to the centreline of the taxiway as possible. However, this can be difficult, particularly when the aircraft is following a curved taxiway, in situations of low visibility (for example at night or due to fog) and/or in situations involving strong crosswinds. Accordingly, a user feedback action performed by the active side stick may be beneficial in assisting the pilot to accurately judge the aircraft's position on the taxiway.

Further, the cross-track error may be based on the current position of the aircraft or a predicted position of the aircraft. The predicted position may be the position that the aircraft is predicted to be in a few seconds in the future based on its current state (e.g. current position, steering angle and speed). Therefore, the pilot may receive feedback on the predicted position of the aircraft and be able to correct the trajectory of the aircraft earlier. (The predicted position may be more or less than a few seconds into the future.)

Additionally, in such embodiments of the invention where the magnitude of the user feedback action is proportional to the cross-track error, the pilot may receive a more precise indication of the aircraft's position on the taxiway and the degree to which corrective steering may be required. For example, if the user feedback action is a vibration of the active side stick, the intensity of vibration would indicate to the pilot the distance of the aircraft from the taxiway centreline.

The actual state of the aircraft, i.e. the position of the aircraft relative to the taxiway centreline, may be measured by any suitable method. For example, the aircraft may comprise a camera that monitors the taxiway beneath and ahead of the aircraft. Such a camera may be located on the vertical stabiliser of the aircraft, as is the case for aircrafts such as the A380 and B787. Positional tracking software may then be applied to the captured images, similarly to lane tracking techniques utilised by modern cars. Alternatively, the position of the aircraft may be determined using an on-board satellite/inertial navigation system in combination with an airport map.

The required state of the aircraft, i.e. the position of the centreline of the taxiway, may also be determined by any suitable method. For example, the positional tracking software mentioned above may be applied to captured images in order to locate the centreline of the taxiway as well as the position of the aircraft on the taxiway. Alternatively, the required position of the aircraft may be defined by a predetermined taxi route of the aircraft relative to an airport map.

The user feedback signal may comprise further differences between the actual state and the required state. For example, the required state may comprise a predetermined taxiing speed and the difference between the actual state and the required state may therefore be a difference between actual speed and required speed. Accordingly, a feedback action may be carried out based on the difference between actual speed and required speed, for example the active side stick may apply a force bias towards an angle of rotation about the first axis that would achieve the required speed.

In embodiments of the invention the method further comprises the step of receiving a disabling signal and disabling the user feedback action from being carried out for a period of time.

In such embodiments of the invention the active side stick may comprise a button (or any suitable control mechanism) to allow the pilot to trigger the generation of a disabling signal. The disabling signal may disable the user feedback action from being carried out for a duration of time during which the disabling signal is being received (for example, while the button is depressed by the pilot), for a predetermined period of time following the receipt of the disabling signal or until the button is pressed a second time to generate a re-enabling signal.

Disabling the user feedback action may be advantageous in instances when the pilot needs to deviate from the taxiway centreline intentionally (for example to avoid obstacles). Being able to disable the user feedback action in this case would reduce nuisance signals from the side stick.

In embodiments of the invention the control signal comprises an impetus level and a brake level, each based on the angle of rotation of the active side stick about the first axis.

In such embodiments of the invention the pilot may control the impetus level and the brake level that are generated by rotating the active side stick about the first axis. The first axis may be equivalent to a pitch axis such that forward and backward deflection of the active side stick corresponds to an adjustment in the impetus and/or brake levels.

The impetus level may be representative of a command issued by the pilot with the intention of setting how much thrust is to be achieved by the aircraft, via deflection of the active side stick about the first axis. For example, the impetus level may be representative of a throttle level, target speed or target acceleration depending on a particular control strategy applied to the aircraft.

In embodiments of the invention the method comprises the further step of limiting the brake level to a maximum brake level such that a deceleration of the aircraft does not exceed a predetermined maximum deceleration value.

In such embodiments of the invention the predetermined maximum deceleration value may be an amount of deceleration up to which passengers in the aircraft are unlikely to experience any discomfort resulting from the deceleration of the aircraft. For example, the predetermined maximum deceleration value may be 1.5 m/s².

Automatically limiting the maximum brake level to ensure the comfort of the passengers is advantageous as it eases the burden on the pilot to factor this in element of controlling the aircraft as well as ensuring a comfortable experience for the passengers.

In embodiments of the invention the method comprises the further steps of:
measuring a deflection pressure applied to the active side stick and a pressure direction relative to the first axis in which the deflection pressure is applied; and
if the deflection pressure exceeds a predetermined pressure value and the pressure direction is negative, increasing the maximum brake level such that there is no limit to the deceleration of the aircraft.

In such embodiments of the invention, if there is an emergency which requires deceleration beyond the predetermined maximum deceleration level the pilot may deflect the active side stick backwards with a large enough force to exceed the predetermined pressure value. This removes the limit on the brake level which exists under usual circumstances and allows a brake level to be determined that decelerates the aircraft as fast as is required. A deceleration may therefore be achieved which is significantly above the predetermined maximum deceleration level if the pilot deems that the emergency situation takes priority over the comfort of the passengers.

In embodiments of the invention the aircraft signal further comprises an actual speed value and the method comprises the further steps of:
limiting the impetus level to a maximum impetus level; and
if the actual speed value is exceeding a maximum allowable speed, reducing the maximum impetus level.

In such embodiments of the invention the maximum allowable speed may be predetermined based on a speed limit imposed on the aircraft by the manufacturer, the airline (according to their standard operating procedures), a particular airport or a particular country. For example, the maximum allowable speed may be predetermined as 30 kts (55.56 km/h).

The maximum impetus level may be limited such that, under typical conditions (such as a flat taxiway with no wind), the maximum allowable speed may not be exceeded. Additionally, the actual speed of the aircraft may be monitored so that in situations where the maximum allowable speed is exceeded, for example if there is a negative gradient to the taxiway or if there is a tailwind, the maximum impetus level may be reduced accordingly to ensure that the actual speed of the aircraft drops below the maximum allowable speed.

A reason for limiting the impetus level may be to limit the thrust level—the amount of thrust developed by the engines of the aircraft. Limiting the thrust level during taxiing is advantageous because it reduces the risk of foreign objects, such as dust and debris, from being injected into the engine and prevents damage being caused to nearby objects or people by jet blast (rapid movement of air caused by jet engines).

The maximum impetus level may be limited according to an algorithm. For instance, the maximum impetus level may be limited such that the maximum thrust level is limited to a predetermined value such as 40%.

In embodiments of the invention, if the actual speed value is exceeding a maximum allowable speed, the method comprises the further step of increasing the brake level in addition to reducing the maximum impetus level.

In such embodiments of the invention the brakes may also be applied to reduce the speed of the aircraft in situations where the maximum allowable speed is exceeded.

This may be particularly advantageous in situations where reducing the impetus level may not be sufficient to reduce the speed of the aircraft, for example if the taxiway has a significant gradient or there are strong tailwinds.

The brake level may be increased according to an algorithm.

In embodiments of the invention the aircraft signal further comprises an actual steering angle and the method comprises the further step of varying the maximum allowable speed based on the actual steering angle.

In such embodiments of the invention the actual steering angle may be based on a steering angle of the nose wheel measured in real time or may be based on knowledge of the taxi route of the aircraft. The maximum allowable speed of the aircraft may be reduced proportionally to the size of the actual steering angle in order to ensure the safety and stability of the aircraft and the comfort of the passengers.

Table 1 shows an example of how the maximum allowable speed may be varied based on the actual steering angle (represented as turn radius).

TABLE 1

| Turn radius | Speed | |
|---|---|---|
| (m) | km/h | kts |
| 15 | 16 | 9 |
| 60 | 32 | 17 |
| 135 | 48 | 26 |

(Aerodrome Design Manual (Part 2) Doc 9157 AN/901, “International Civil Aviation Organisation, 2005.)

In embodiments of the invention the method further comprises the step of receiving a de-limiting signal and disabling the maximum allowable speed such that neither the impetus level nor the brake level is varied based on the maximum allowable speed for a period of time.

In such embodiments of the invention the active side stick may comprise a button (or any suitable control mechanism) to allow the pilot to trigger the generation of a de-limiting signal. The de-limiting signal may disable the maximum allowable speed such that there is no artificially imposed limit to the speed of the aircraft. In other words, the impetus level may be increased to the maximum level that the aircraft is capable of and braking will not be applied above a predetermined speed. The de-limitation of the aircraft's speed may be carried out for a duration of time during which the de-limiting signal is being received (for example, while the button is depressed by the pilot), for a predetermined period of time following receipt of the de-limiting signal or until the button is pressed a second time to generate a re-limiting signal.

Disabling the maximum allowable speed may be advantageous in instances when the pilot needs to increase speed above the maximum allowable speed, for example to avoid a hazard. Being able to disable the maximum allowable speed ensures that the pilot has ultimate control authority and may carry out any controls necessary to ensure safety of the aircraft and its passengers.

In some embodiments of the invention the control mechanism, forming part of the active side stick, that generates a de-limiting signal may also generate the disabling signal described above. The pilot may therefore use the control mechanism to temporarily convert the active side stick to a passive side stick so that the pilot has ultimate control authority. In other embodiments the de-limiting signal and the disabling signal may be generated by separate control mechanisms.

In embodiments of the invention the control signal comprises a target steering angle based on the angle of rotation of the active side stick about the second axis.

In such embodiments of the invention the pilot may control the target steering angle that is generated by rotating the active side stick about the second axis. The second axis may be equivalent to a roll axis such that left or right deflection of the active side stick corresponds to an adjustment in the target steering angle to the left or right respectively.

In embodiments of the invention the method further comprises the step of determining an asymmetric thrust compensation factor, wherein the target steering angle is additionally based on the asymmetric thrust compensation factor.

In such embodiments of the invention the aircraft may taxi using only one of its engines, in order to reduce fuel consumption for example. The asymmetric thrust compensation factor may be calculated based on what compensation is required to be made to the nose wheel steering angle to compensate for the asymmetric thrust generated by the single engine as opposed to the symmetrical thrust that may be achieved by two engines.

Such embodiments of the invention circumvent the need for the pilot to manually compensate the steering commands for the asymmetrical thrust developed when taxiing with a single engine. Therefore the risk associated with human error is reduced and the taxiing operation is less demanding on the pilot and the pilot may focus on other tasks.

In embodiments of the invention, if the target steering angle exceeds a predetermined steering value, the control signal is generated such that it further comprises a differential thrust/brake level.

In such embodiments of the invention the predetermined steering value may be a predetermined angle of steering below a maximum possible steering angle. For example, the maximum possible steering angle achievable by the aircraft may be ±75° from straight and the predetermined steering value may be ±70° from straight. However, each of the maximum possible steering angle and the predetermined steering value may be any suitable angle.

When the target steering exceeds the predetermined steering value a differential thrust/brake level is generated to assist the aircraft in achieving the target steering angle. Differential thrusting involves increasing the thrust developed on one side of the aircraft more than the other side of the aircraft in order to encourage the aircraft to turn. Differential braking similarly involves applying brakes to the landing gear (undercarriage) on one side of the aircraft more strongly than on the other side of the aircraft in order to encourage the aircraft to turn. For example, to steer right greater thrust could be applied on the left side of the aircraft and/or greater braking could be applied on the right side of the aircraft, and vice versa in order to steer left.

The differential thrust/brake level may be increased proportionally to the amount that the predetermined steering value is exceeded by the target steering angle. For example, if the target steering angle is equal to the predetermined steering value then the differential thrust/brake level may be 0 such that no differential thrusting or braking occurs. If the target steering angle is equal to the maximum possible steering angle then the differential thrust/brake level may be maximum, i.e. if turning right the left thrust and right brake levels would be set to a maximum differential level whereas the right thrust and left brake levels would be set to 0. Accordingly, differential thrusting and braking may be utilised by the pilot in order to carry out particularly tight manoeuvres of the aircraft.

In embodiments of the invention the aircraft signal comprises an actual speed value and the method comprises the further steps of:
limiting the target steering angle to a maximum target steering angle; and
varying the maximum target steering angle based on the actual speed value.

In such embodiments of the invention the maximum target steering angle may be reduced proportionally to the actual speed value. This protects the nose wheel from being positioned at high steering angles when the aircraft is also travelling at high speeds as this would result in high levels of friction that may damage the nose wheel. This allows the aircraft to comply with safety requirements such as those cited in “Certification Specifications and Acceptable Means of Compliance for Large Aeroplanes CS-25 Amendment 22,” European Aviation Safety Agency, 2018.

In embodiments of the invention the impetus level causes a throttle action affecting the actual state of the aircraft and the brake level causes a brake action affecting the actual state of the aircraft.

In such embodiments of the invention the pilot may apply a deflection to the active side stick causing an angle of rotation about the first axis and in response a control signal may be generated comprising impetus and/or brake levels based on the deflection. The impetus and/or brake levels may in turn cause the aircraft to carry out a throttle action and/or brake action. Accordingly, the pilot may manipulate the active side stick to control the throttle and braking of the aircraft.

In embodiments of the invention the control signal is generated such that if the angle of rotation of the active side stick about the first axis is less than or equal to 0° the throttle action caused is to set a throttle level to zero and if the angle of rotation of the active side stick about the first axis is a maximum positive angle the throttle action caused is to set the throttle level corresponding to the maximum impetus level.

In such embodiments of the invention the pilot may control the throttle level by adjusting the forward deflection of the active side stick wherein no forward deflection results in no throttle being applied (resulting in idle thrust) and maximum forward deflection causes a throttle level to be applied that corresponds to a maximum impetus level.

The throttle level corresponding to the maximum impetus level may not be a maximum possible throttle level. As set out above, the maximum impetus level may be limited in order to avoid exceeding a maximum allowable speed and/or limit the thrust level to prevent damage due to jet blast or ingestion of foreign objects into the engine. Further, the maximum impetus level may be varied based on environmental conditions or steering angle. Therefore the throttle level corresponding to the maximum impetus level may be a fraction of the maximum possible throttle level of the relevant aircraft.

The amount of forward deflection (between 0 and maximum) of the active side stick may correspond proportionally to the amount of throttle that is applied. In some embodiments of the invention the proportionality may be based on a linear relationship between the positive angle of rotation of the active side stick about the first axis and the throttle level. Therefore the deflection of the active side stick required by the pilot may be directly comparable to the deflection that would be required of throttle levers in known aircrafts. In other embodiments of the invention the proportionality may be based on a non-linear relationship which may allow more precise control to be exerted at low speeds.

In embodiments of the invention the control signal is generated such that if the angle of rotation of the active side stick about the first axis is greater than or equal to 0° the brake action caused is to set a brake application level to none and if the angle of rotation of the active side stick about the first axis is a maximum negative angle the brake action caused is to set the brake application level corresponding to the maximum brake level.

In such embodiments of the invention the pilot may control the brake level by adjusting the backward deflection of the active side stick wherein no backward deflection corresponds to no braking being applied and maximum backward deflection causes a brake application level to be set that corresponds to a maximum brake level.

The brake application level corresponding to the maximum brake level may not be a maximum possible brake application level. As set out above, the maximum brake level may be limited in order to avoid exceeding a predetermined maximum deceleration value. Further, the maximum brake level may be varied based on whether emergency braking is required. Therefore the brake application level corresponding to the maximum brake level may be a fraction of the maximum possible braking application level of the relevant aircraft. However, if emergency braking is required, the maximum brake level may correspond to the maximum brake application level that is available for the aircraft, thereby allowing the pilot to take full advantage of the maximum braking capability of the aircraft if required.

Further, the amount of backward deflection (between 0 and maximum) of the active side stick may correspond proportionally to the amount of braking that is applied. In some embodiments of the invention the proportionality may be based on a linear relationship between the negative angle of rotation of the active side stick about the first axis and the brake level. In other embodiments of the invention the proportionality may be based on a non-linear relationship.

In other embodiments of the invention the impetus level and the brake level are representative of a target speed and the control signal is generated such that if the angle of rotation of the active side stick about the first axis is 0° the throttle action and brake action caused are to set the throttle level and the brake application level respectively to achieve an actual speed value of 0 km/h and if the angle of rotation of the active side stick about the first axis is a maximum angle the throttle action and brake action caused are to set the throttle level and the brake application level respectively to achieve an actual speed value equal to a maximum allowable speed.

In such embodiments of the invention the pilot may set a target speed for the aircraft by adjusting the forward deflection of the active side stick wherein no forward deflection corresponds to the aircraft being stationary (a speed of 0 km/h) and maximum forward deflection corresponds to the maximum allowable speed (which may be dependent on the angle of steering). The throttle level and brake application level required to achieve the target speed set by the angle of rotation of the active side stick about the first axis may be calculated using any suitable control technique, such as PID control or fuzzy logic control.

Further, the amount of forward deflection (between 0 and maximum) of the active side stick may correspond proportionally to the target speed. In some embodiments of the invention the proportionality may be based on a linear relationship between the positive angle of rotation of the active side stick about the first axis and the throttle level. In other words X° of rotation of the active side stick about the first axis may equal f*X km/h of adjustment to the target speed, where f is a constant (the gradient). In other embodiments of the invention the proportionality may be based on a non-linear relationship which may allow more precise control to be exerted at low speeds.

Additionally, in some embodiments of the invention, backward deflection of the active side stick may be restricted such that it is not possible to set a negative velocity.

In other embodiments of the invention the impetus level is representative of a target acceleration and the control signal is generated such that if the angle of rotation of the active side stick about the first axis is 0 the throttle action caused is to set the throttle level to achieve an acceleration of 0 m/s² and if the angle of rotation of the active side stick about the first axis is a maximum positive angle the throttle action caused is to set the throttle level to achieve a maximum acceleration.

In such embodiments of the invention the pilot may set a target acceleration for the aircraft by adjusting the forward deflection of the active side stick wherein no forward deflection corresponds to the aircraft maintaining a constant speed (an acceleration of 0 m/s²) and maximum forward deflection corresponds to the maximum possible acceleration, i.e. maximum impetus level and no braking. The throttle level required to achieve the target acceleration set by the angle of rotation of the active side stick about the first axis may be calculated using any suitable control technique, such as PID control or fuzzy logic control.

Further, the amount of forward deflection (between 0 and maximum) of the active side stick may correspond proportionally to the target acceleration. In some embodiments of the invention the proportionality may be based on a linear relationship between the positive angle of rotation of the active side stick about the first axis and the target acceleration. In other words X° of rotation of the active side stick about the first axis may equal f*X m/s² of adjustment to the target acceleration, where f is a constant (the gradient). In other embodiments of the invention the proportionality may be based on a non-linear relationship which may allow more precise control to be exerted at low changes in acceleration.

In embodiments of the invention the brake level is representative of a target deceleration and the control signal is generated such that if the angle of rotation of the active side stick about the first axis is 0 the brake action caused is to set the brake application level to achieve a deceleration of 0 m/s² and if the angle of rotation of the active side stick about the first axis is a maximum negative angle the brake action caused is to set the brake application level to achieve a maximum deceleration.

In such embodiments of the invention the pilot may set a target deceleration for the aircraft by adjusting the backward deflection of the active side stick wherein no backward deflection corresponds to the aircraft maintaining a constant speed (an acceleration of 0 m/s²) and maximum backward deflection corresponds to the maximum possible deceleration, which may be defined by the predetermined maximum deceleration value. The brake application level required to achieve the target deceleration set by the angle of rotation of the active side stick about the first axis may be calculated using any suitable control technique, such as PID control or fuzzy logic control.

Further, the amount of backward deflection (between 0 and maximum) of the active side stick may correspond proportionally to the target deceleration. In some embodiments of the invention the proportionality may be based on a linear relationship between the negative angle of rotation of the active side stick about the first axis and the target deceleration. In other words X° of rotation of the active side stick about the first axis may equal f*X m/s² of adjustment to the target deceleration, where f is a constant. In other embodiments of the invention the proportionality may be based on a non-linear relationship which may allow more precise control to be exerted at low changes in deceleration.

In embodiments of the invention the target steering angle causes a nose wheel action.

In such embodiments of the invention the pilot may apply a deflection to the active side stick causing an angle of rotation about the second axis and in response a control signal may be generated comprising a target steering level based on the deflection. The target steering level may in turn cause the aircraft to carry out a nose wheel action. Accordingly, the pilot may manipulate the active side stick to control the angle of the nose wheel of the aircraft.

In embodiments of the invention the target steering angle is representative of a nose wheel angle.

In such embodiments of the invention the pilot may control the angle of the nose wheel by adjusting the deflection of the active side stick in the left and right directions wherein no left or right deflection corresponds to no steering and maximum left or right deflection of the active side stick corresponds to maximum steering left or right respectively.

Further, the amount of sideways deflection (maximum left and maximum right) of the active side stick may correspond proportionally to the change in the nose wheel angle that is set. In some embodiments of the invention the proportionality may be based on a linear relationship between the angle of rotation of the active side stick about the second axis and the nose wheel angle. In other words, X° of rotation of the active side stick about the second axis may equal f*X° of adjustment to the angle of the nose wheel, where f is a constant.

In other embodiments of the invention the proportionality may be based on a non-linear relationship to vary steering sensitivity through the range of possible steering angles and therefore allow the pilot to exert more precise control of the nose wheel angle when it is within a predetermined range. For example, the non-linear relationship between the active side stick angle and the resulting nose wheel angle may be configured to provide less sensitive (and more precise) steering at low steering angles (e.g. ±10°). This could be advantageous as low steering angles would commonly be used at higher speeds when rapid changes in the nose wheel angle could cause damage to the nose wheel and instability to the aircraft.

In embodiments of the invention the target steering angle is representative of a steering angle rate.

In such embodiments of the invention the pilot may set a steering angle rate wherein a certain angle of rotation of the active side stick about the second axis equates to the target angle of the nose wheel changing by a certain amount per second. This means that if the angle of rotation of the active side stick about the second axis is 0° the steering angle may remain constant. If the angle of rotation of the active side stick about the second axis is maximum then the nose wheel action may involve the angle of the nose wheel changing in the relevant direction as quickly as possible with respect to a predetermined factor. For example, the steering angle rate may be limited based on the limitations of the aircraft or a predetermined limitation to ensure the steering is within safety limits and/or is comfortable for passengers.

Further, the amount of sideways deflection (maximum left and maximum right) of the active side stick may correspond proportionally to the steering angle rate that is set. In some embodiments of the invention the proportionality may be based on a linear relationship between the angle of rotation of the active side stick about the second axis and the steering angle rate. In other embodiments of the invention the proportionality may be based on a non-linear relationship which may allow the pilot to exert more precise control of the steering angle rate for small alterations.

In embodiments of the invention the method comprises the further step of returning the active side stick to a neutral position such that the angles of rotation about the first axis and the second axis are 0 if there is no deflection pressure applied to the active side stick.

In such embodiments of the invention, the active side stick returns to a neutral position when the pilot releases it (or applies no deflection pressure). For example, in embodiments of the invention where the angle of rotation of the active side stick about the first axis corresponds to a throttle level and a brake application level, the active side stick returns to a position corresponding to idle throttle and no brake application. This means that the aircraft enters a neutral state in which it will either coast at idle thrust or coast to a stationary position if it is not already stationary (depending on the type of aircraft).

In embodiments of the invention the method comprises the further step of holding the active side stick in its current position such that the angles of rotation about the first axis and the second axis stay constant if there is no deflection pressure applied to the active side stick.

In such embodiments of the invention, the active side stick maintains its position when the pilot releases it (or applies no deflection pressure). For example, in embodiments of the invention where the angle of rotation of the active side stick about the first axis corresponds to a throttle level and a brake application level, the active side stick maintaining its position means that the throttle and braking levels remain constant. This means that, if the active side stick is released with a forward deflection, the aircraft will maintain its current throttle level. If the active side stick is released with a backward deflection, the aircraft will maintain its current brake application level and will soon become stationary.

An advantage of such embodiments of the invention is that the pilot does not need to apply a continuous force to the active side stick, thus potentially reducing the pilot's workload.

In embodiments of the invention the step of generating a control signal comprises the step of using a control algorithm and optionally the control algorithm is a PID control algorithm or a fuzzy logic control algorithm.

In such embodiments of the invention the step of generating a control signal (and therefore controlling the aircraft) may comprise the step of using any suitable control algorithm.

In embodiments of the invention the step of generating a control signal using a fuzzy logic control algorithm comprises the steps of:
determining a fuzzified input based on one or both of the angle of rotation of the active side stick about the first axis and the second axis and the aircraft signal,
determining a fuzzified output based on the fuzzified input and a set of fuzzy rules,
determining a de-fuzzified output based on the fuzzified output wherein the control signal is representative of the de-fuzzified output.

In other embodiments of the invention the step of generating a control signal comprises the step of using a PID control algorithm.

According to an aspect of the invention there is provided a system for controlling an aircraft when taxiing configured to carry out a method according to any preceding claim.

The invention will now be described by way of example only with reference to the accompanying drawings in which:

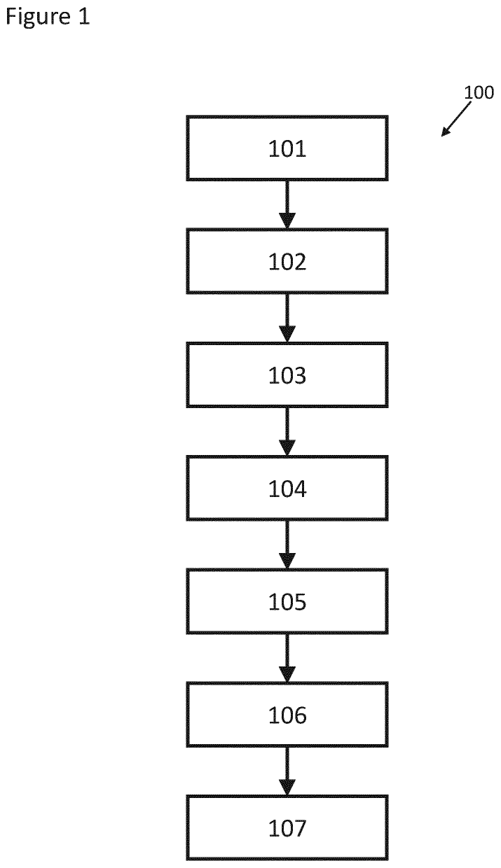

FIG. 1 is a schematic representation of a method according to an aspect of the invention;

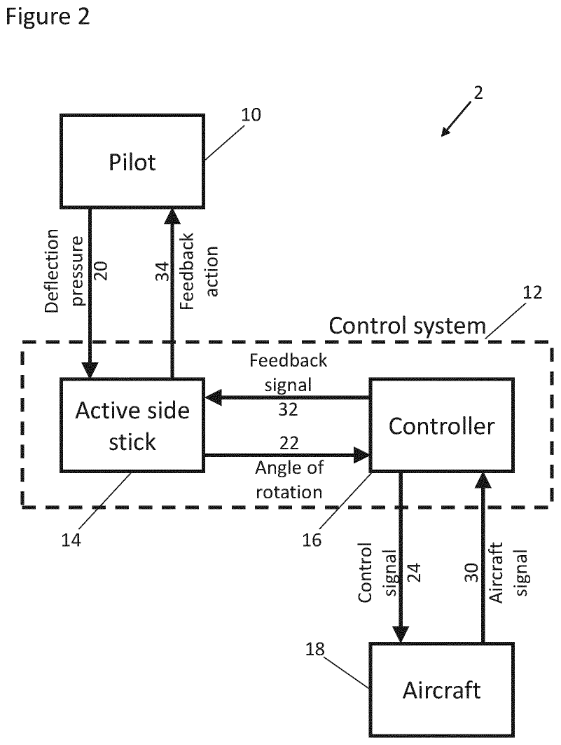

FIG. 2 is a schematic representation of a system according to an aspect of the invention with which the method shown in FIG. 1 may be performed;

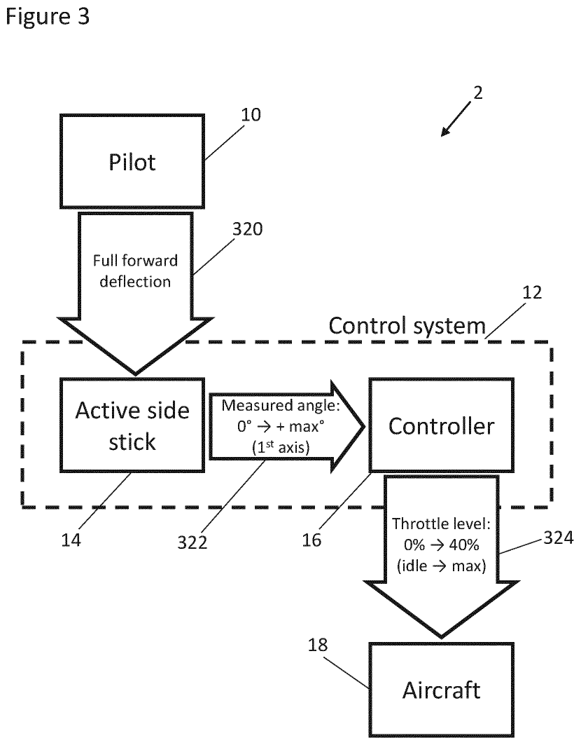

FIGS. 3 to 13 are each a schematic representation of control steps forming part of a method according to an embodiment of the invention being performed with the system shown in FIG. 2;

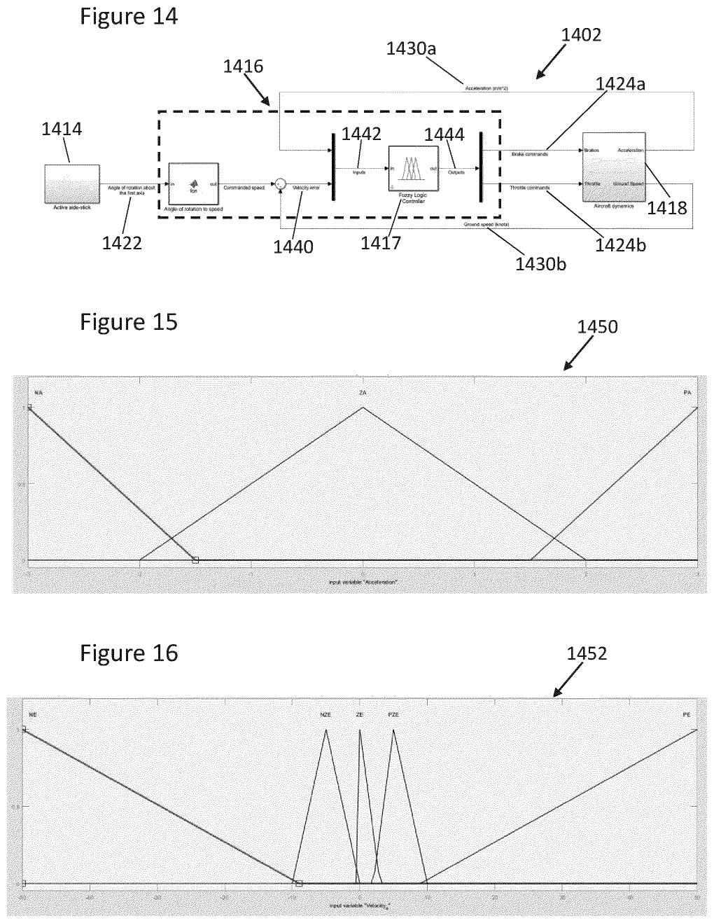

FIG. 14 is a schematic representation of control and feedback steps forming part of a method according to an embodiment of the invention using fuzzy logic control;

FIG. 15 is a graphical representation of a predetermined input membership function for acceleration;

FIG. 16 is a graphical representation of a predetermined input membership function for velocity error;

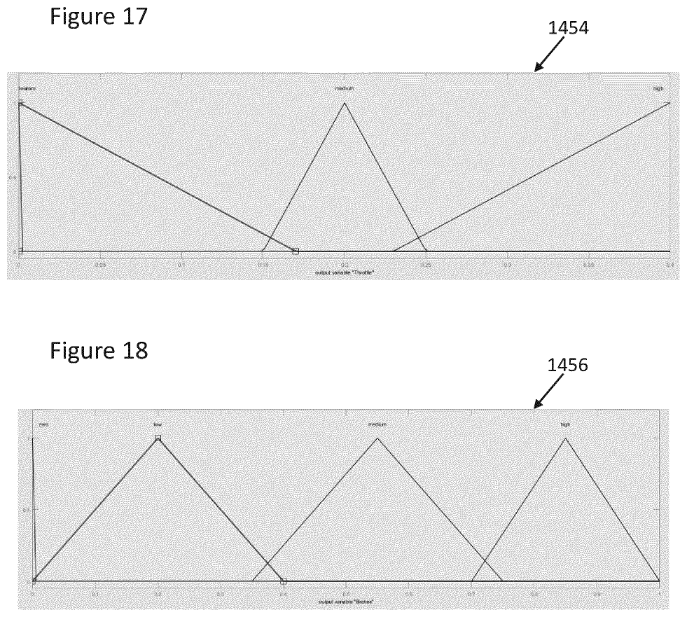

FIG. 17 is a graphical representation of a predetermined output membership function for throttle position;

FIG. 18 is a graphical representation of a predetermined output membership function for brake position;

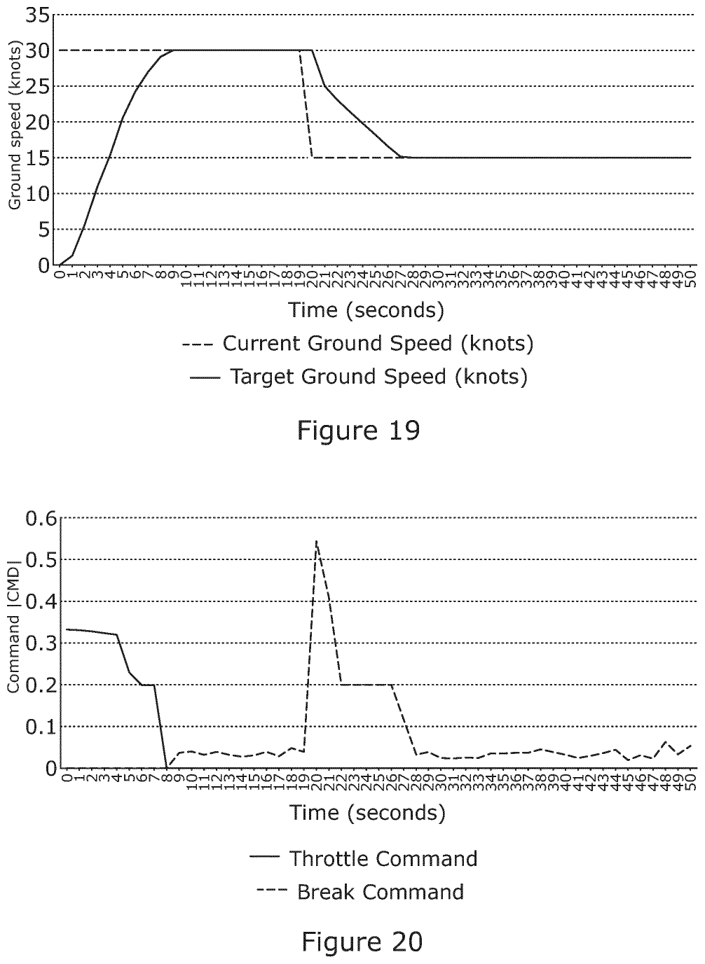

FIG. 19 is a graphical representation of target speed and actual speed against time for an aircraft controlled with a method according to an embodiment of the invention;

FIG. 20 is a graphical representation of throttle and brake commands issued to achieve the actual speed shown in FIG. 19, based on the target speed shown in FIG. 19;

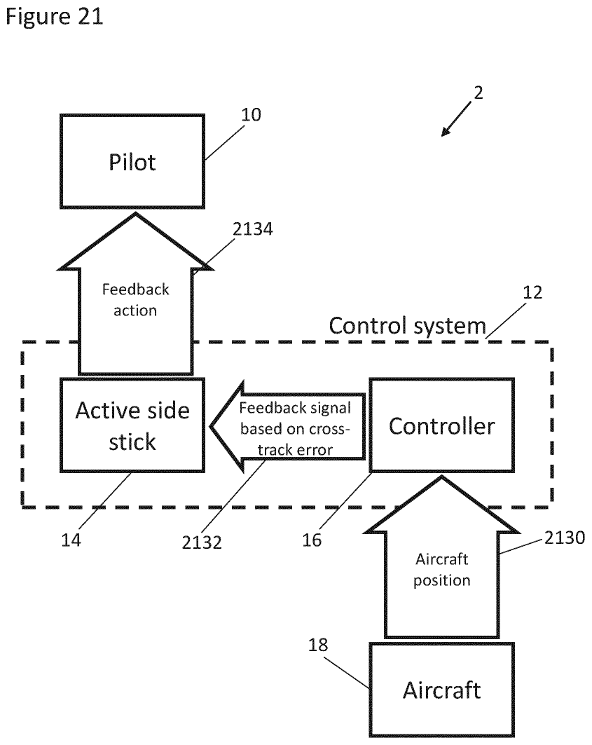

FIG. 21 is a schematic representation of user feedback steps forming part of a method according to an embodiment of the invention being performed with the control system shown in FIG. 2.

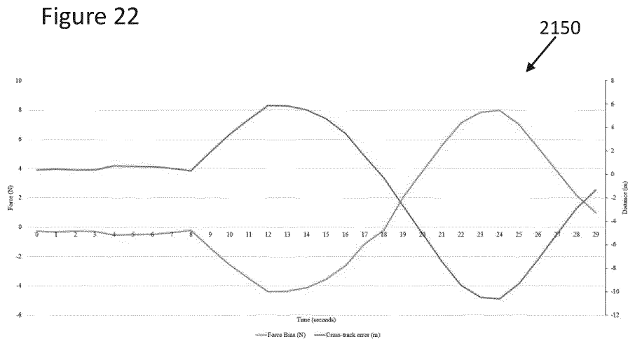

FIG. 22 is a graphical representation of a user feedback action carried out by an active side stick in response to a cross-track error according to an embodiment of the invention.

Referring initially to FIG. 1, a method according to the invention is generally defined by the reference numeral 100 and comprises the steps 101, 102, 103, 104, 105, 106 and 107. The method 100 is a method for controlling an aircraft when taxiing and may be carried out by a control system forming part of the aircraft. The control system may comprise a controller and an active side stick which a pilot of the aircraft may interact with in order to control the aircraft.

The active side stick may be adapted to be rotatable about the first and second axes, which may be equivalent to pitch and roll axes respectively. The pilot may rotate, or deflect, the active side stick about one of the first and second axes or a combination of both axes in order to issue a control command. For example, if the pilot wants the aircraft to accelerate forwards the pilot would deflect the active side stick forward, which may correspond to a positive angle of rotation about the first axis. Similarly, a command for the aircraft to steer right and left may be issued by deflecting the active side stick to the right and left respectively and a command for the aircraft to brake may be issued by deflecting the active side stick backwards.

Step 101 involves measuring an angle of rotation of the active side stick about the first axis and the second axis. Step 101 therefore translates the physical movement of the active side stick performed by the pilot into a data signal which may be received by the controller.

In order for accurate control of the aircraft to be determined, the controller is required to compare the command issued by the pilot with the current state of the aircraft. For example, if the pilot deflects the active side stick to issue a steering command, information relating to the current steering angle of the aircraft is crucial in order for the controller to determine the action required.

Further, the current state of the aircraft must be known in order to provide the pilot with feedback based on the current state of the aircraft.

Accordingly, step 102 involves receiving an aircraft signal comprising an actual state of the aircraft.

Step 103 involves generating a control signal based on at least one of: the aircraft signal and the angle of rotation of the active side stick about a first axis and a second axis. Step 103 may be carried out by the controller according to one or more algorithms and according to any suitable control technique such as PID control or fuzzy logic control.

The control signal may comprise a impetus level and a brake level, each based on the angle of rotation of the active side stick about the first axis.

Excessive braking of the aircraft can be uncomfortable for passengers of the aircraft. Therefore the brake level may be limited to a maximum brake level such that a deceleration of the aircraft does not exceed a predetermined maximum deceleration value. For example, the predetermined maximum deceleration value may be 1.5 m/s².

However, in some instances higher brake levels may be required, in emergency situations for example. Accordingly, step 103 may comprise the further steps of measuring a deflection pressure applied to the active side stick and a pressure direction relative to the first axis in which the deflection pressure is applied; and, if the deflection pressure exceeds a predetermined pressure value and the pressure direction is negative, increasing the maximum brake level such that there is no limit to the deceleration of the aircraft.

Speed limits may be imposed on aircrafts when taxiing. In order to comply with a speed limit, the aircraft signal of step 102 may comprise an actual speed value and step 103 may comprise the further steps of limiting the impetus level to a maximum impetus level and, if the actual speed value is exceeding a maximum allowable speed, reducing the maximum impetus level. Further, the brake level may be increased in addition to reducing the maximum impetus level. The reduction to the maximum impetus level and the increase to the brake level may be calculated, according to an algorithm, in order to reduce the actual speed value slightly below the maximum allowable speed.

In order to protect the integrity of the nose wheel of the aircraft (which sets the steering angle), it may be advantageous to reduce the maximum allowable speed as the steering angle of the nose wheel increases. Therefore, the aircraft signal of step 102 may comprise an actual steering angle and step 103 may comprise the further step of varying the maximum allowable speed based on the actual steering angle.

The control signal may be generated to comprise a target steering angle based on the angle of rotation of the active side stick about the second axis. If the target steering angle exceeds a predetermined steering value, the control signal generated in step 103 may further comprise a differential thrust/brake level.

Similarly to reducing the maximum allowable speed in a turn to protect the integrity of the nose wheel, it may be advantageous to reduce the maximum amount that the nose wheel may be steered when the aircraft is travelling at a certain speed.

Accordingly, step 103 may comprise the further steps of limiting the target steering angle to a maximum target steering angle and varying the maximum target steering angle based on the actual speed value.

The control signal, which may comprise a impetus level, a brake level, a target steering angle or a combination of these elements, must be received by the aircraft in order for the commands to be actioned. Therefore, step 104 involves transmitting the control signal to the aircraft, whereby the control signal causes an action affecting the actual state of the aircraft.

Step 105 involves determining a required state of the aircraft. The required state of the aircraft may be a target position of the aircraft relative to the taxiway, a target speed, a target acceleration or a target steering angle, for example.

Step 106 involves generating a user feedback signal based on a difference between the actual state and the required state.

Step 107 involves carrying out a user feedback action based on the user feedback signal. Step 107 may be performed by the active side stick.

The user feedback signal may be generated, in Step 106, such that the magnitude of the user feedback action of Step 107 is proportional to the difference between the actual state and the required state. For example, if the user feedback action of Step 107 is a vibration of the active side stick, the intensity of the vibration may vary proportionally to variation of the difference between the actual state and the required state.

The difference between the actual state and the required state may be a cross-track error representative of the shortest distance between an aircraft position on a taxiway and a centreline of the taxiway. Therefore, the user feedback action of Step 107 may indicate to the pilot that the aircraft is diverting from the centreline and the magnitude of the user feedback action (the intensity of vibration, for example) may indicate the degree to which the aircraft is diverting from the centreline.

Referring now to FIG. 2, an aircraft taxiing system is generally defined by the reference numeral 2 and comprises a pilot 10, a control system 12 and an aircraft 18.

The control system 12 may be configured to carry out the method 100 shown in FIG. 1 and comprises an active side stick 14 and a controller 16.

The pilot 10 may apply a deflection pressure 20 to the active side stick which may cause the active side stick to rotate about a first axis and/or a second axis. The angle of rotation of the active side stick 14 may then be measured, according to step 101 of the method 100, as an angle of rotation 22. The angle of rotation 22 may be transmitted from the active side stick 14 to the controller 16. Simultaneously, the controller may receive an aircraft signal 30 from the aircraft 18 in accordance with step 102. The controller 16 may then generate a control signal 24 based on at least one of: the aircraft signal 30 and the angle of rotation 22, in accordance with step 103.

The control signal 24 may then be transmitted to the aircraft 18 from the controller 16, in accordance with step 104.

The controller 16 may also generate a user feedback signal 32 based on the aircraft signal, in accordance with step 105, and transmit the user feedback signal 32 to the active side stick 14. The active side stick 14 may carry out a user feedback action 34 based on the user feedback signal 32.

Accordingly the pilot 10 may issue a control command to the aircraft 18 and receive feedback on a dynamic state of the aircraft 18 via the control system 12 wherein the control system 12 acts according to the method 100.

The control signal 24 may comprise an impetus level and a brake level, each based on the angle of rotation of the active side stick about the first axis. The impetus level may cause a throttle action affecting the actual state of the aircraft and the brake level may cause a brake action affecting the actual state of the aircraft.

Similarly, the control signal may comprise a target steering angle based on the angle of rotation of the active side stick about the second axis, wherein the target steering angle causes a nose wheel action.

However exact actions required of the pilot 10 in order to control the aircraft 18 as desired may depend on the configuration of the control system 12 according to a specific embodiment of the invention. Table 2 sets out five exemplary control strategies according to different embodiments of the invention.

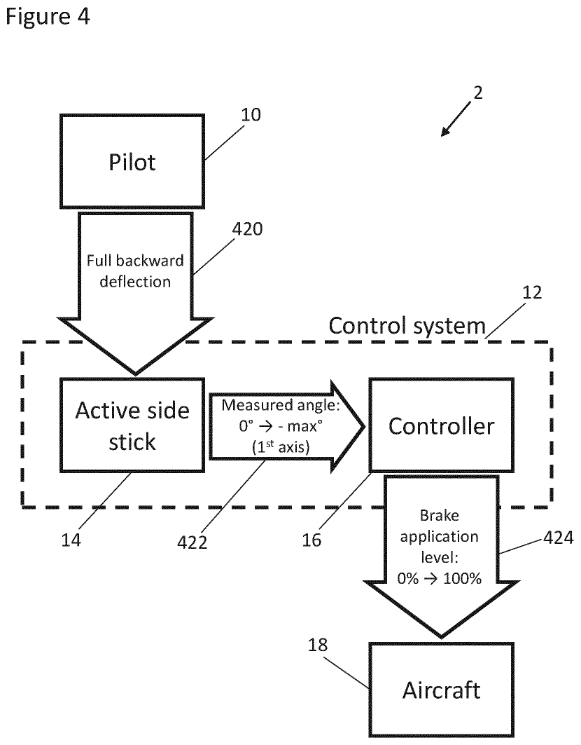

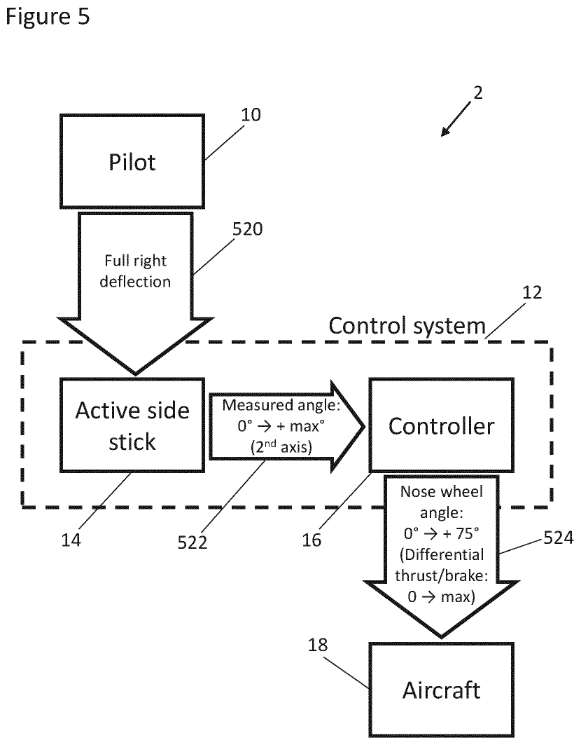

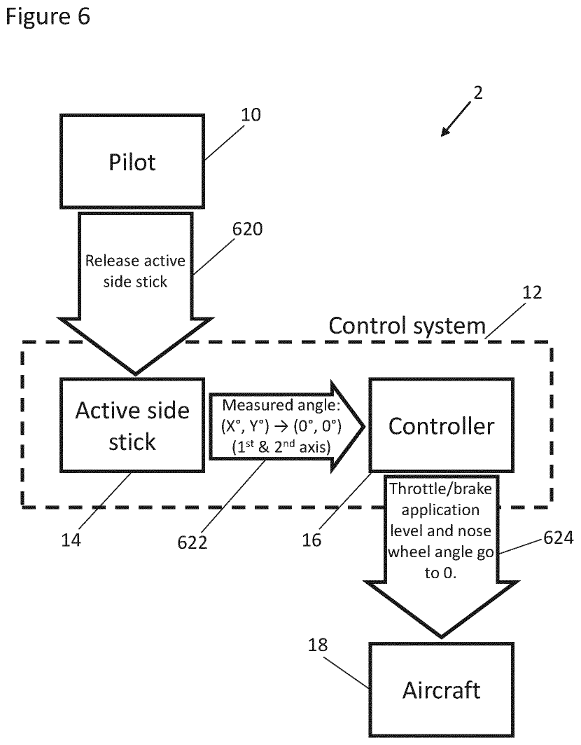

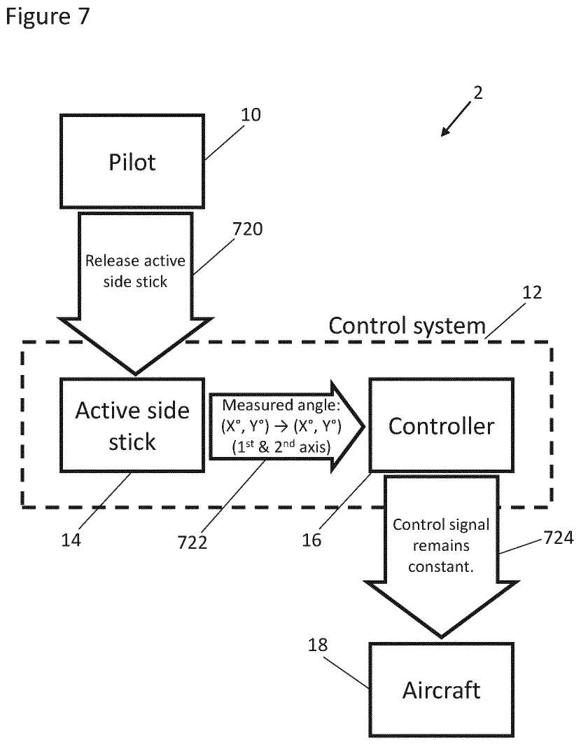

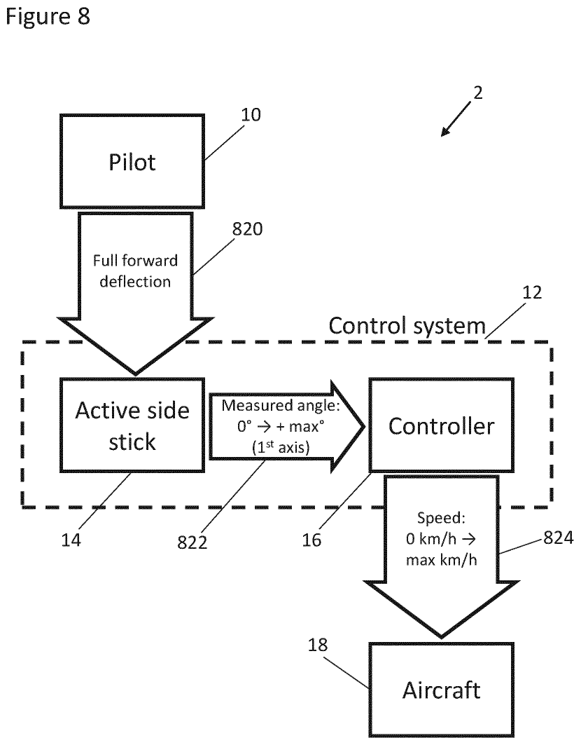

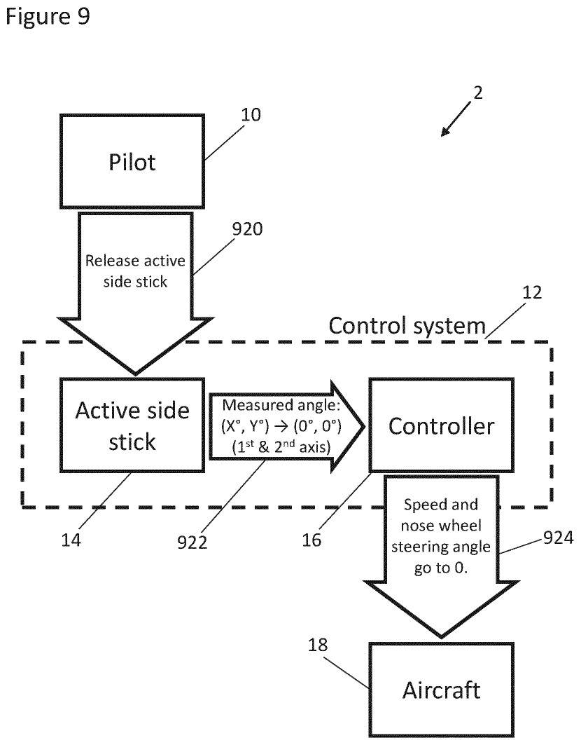

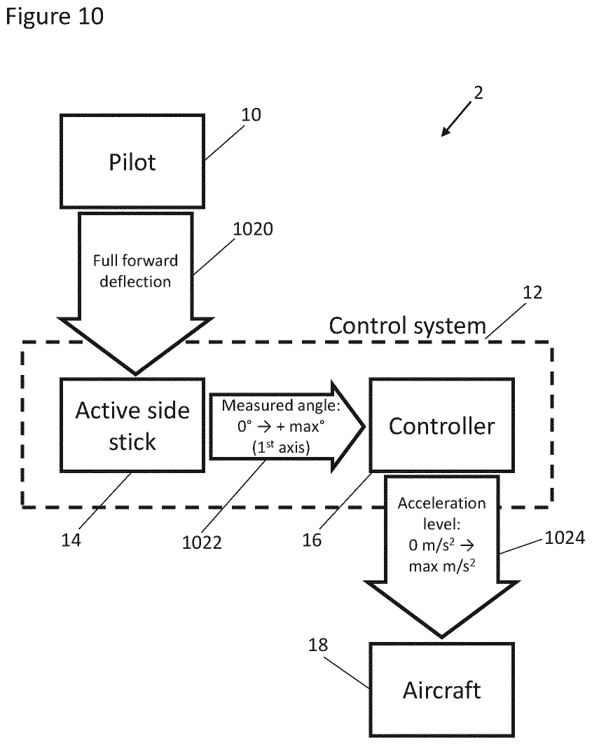

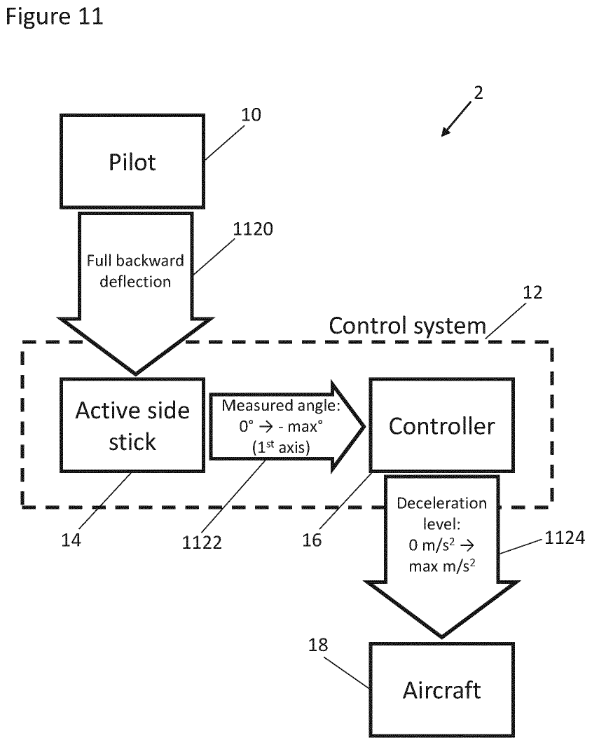

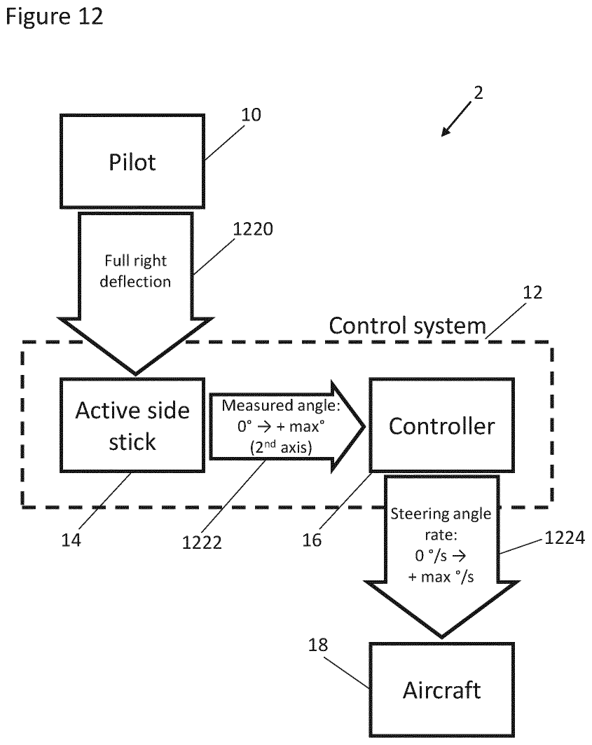

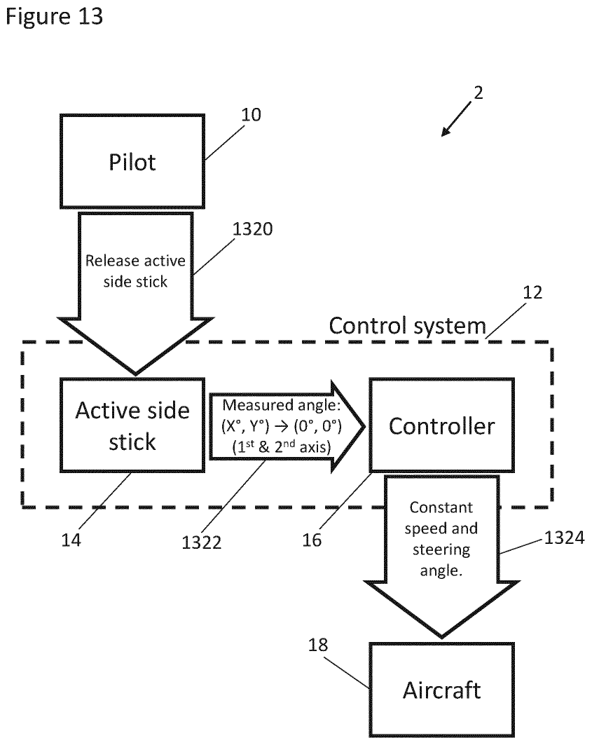

TABLE 2

| | | Axis: | | | | |
|---|---|---|---|---|---|---|
| Deflection | | First axis (pitch) | | | Second axis (roll) | |
| pressure: | | Forward | Backward | 0 | Left/Right | 0 |
| Control | 1 | Adjust throttle | Apply left and | Neutral | Steer nose | Neutral |
| strategy: | | position of | right brakes. | position. | wheel | position. |
| | | both engines | Emergency | Idle thrust and | left/right. | 0° steering |
| | | according to | braking | no brakes. | Differential | angle. |
| | | deflection. | beyond a | (FIG. 6) | thrust/brakes | (FIG. 6) |
| | | (FIG. 3) | certain | | beyond a | |
| | | | pressure. | | certain angle. | |
| | | | (FIG. 4) | | (FIG. 5) | |
| | 2 | Adjust throttle | Apply left and | Side stick | Steer nose | Side stick |
| | | position of | right brakes. | remains in | wheel | remains in |
| | | both engines | Emergency | same position | left/right. | same position |
| | | according to | braking | and | Differential | and |
| | | deflection. | beyond a | commands are | thrust/brakes | commands |
| | | (FIG. 3) | certain | unchanged. | beyond a | are |
| | | | pressure. | (FIG. 7) | certain angle. | unchanged. |
| | | | (FIG. 4) | | (FIG. 5) | (FIG. 7) |
| | 3 | Adjust aircraft | Emergency | Neutral | Steer nose | Neutral |
| | | speed | braking | position. | wheel | position. |
| | | according to | beyond a | Reduce speed | left/right. | 0° steering |
| | | deflection. | certain | to 0 (apply | Differential | angle. |
| | | (FIG. 8) | pressure. | idle thrust and | thrust/brakes | (FIG. 9) |
| | | | | brakes). | beyond a | |
| | | | | (FIG. 9) | certain angle. | |
| | | | | | (FIG. 5) | |
| | 4 | Adjust aircraft | Emergency | Side stick | Steer nose | Side stick |
| | | speed | braking | remains in | wheel | remains in |
| | | according to | beyond a | same position | left/right. | same position |
| | | deflection. | certain | and | Differential | and |
| | | (FIG. 8) | pressure. | commands are | thrust/brakes | commands |
| | | | | unchanged. | beyond a | are |
| | | | | (FIG. 7) | certain angle. | unchanged. |
| | | | | | (FIG. 5) | (FIG. 7) |
| | 5 | Adjust aircraft | Adjust aircraft | Neutral | Adjust rate of | Neutral |
| | | acceleration | deceleration | position. | steering. | position. |
| | | according to | according to | Acceleration | Differential | Steering angle |
| | | deflection. | deflection. | command is 0. | thrust/brakes | rate command |
| | | (FIG. 10) | (FIG. 11) | Constant | beyond a | is 0. |
| | | | | speed. | certain angle. | Constant |
| | | | | (FIG. 13) | (FIG. 12) | steering |
| | | | | | | angle. |
| | | | | | | (FIG. 13) |

Different aspects of the control strategies are represented in FIGS. 3 to 13 and further described below.

In control strategy (CS) 1 the control signal is generated such that if the angle of rotation of the active side stick about the first axis is less than or equal to 0° the throttle action caused is to set a throttle level to zero (resulting in idle thrust) and if the angle of rotation of the active side stick about the first axis is a maximum positive angle the throttle action caused is to set the throttle level corresponding to the maximum impetus level. Further, the control signal is generated such that if the angle of rotation of the active side stick about the first axis is greater than or equal to 0° the brake action caused is to set a brake application level to none and if the angle of rotation of the active side stick about the first axis is a maximum negative angle the brake action caused is to set the brake application level corresponding to the maximum brake level. The maximum brake level may be limited such that the deceleration does not exceed a predetermined value (unless emergency braking is applied).

FIGS. 3 and 4 show the controls that may therefore be implemented according to CS1. In particular, in FIG. 3 the pilot 10 applies a deflection pressure 320 to the active side stick 14 (which started in a neutral position) resulting in a full forward deflection. The angle of rotation 322 that is measured therefore changes from 0° about the first axis to a maximum positive angle (+max°). The controller 16 then generates a control signal 324 comprising an impetus level and transmits the control signal 324 to the aircraft 18. The impetus level causes a throttle action involving the throttle level changing from idle to a maximum throttle level (40% in this case) in accordance with the measured angle of rotation 322. The throttle action may be carried out with respect to the actual throttle levers of the aircraft 18.

The maximum throttle level may not be a maximum possible throttle level and may instead correspond to a maximum impetus level. The maximum impetus level may be limited in order to avoid exceeding a maximum allowable speed and/or limit the thrust level to prevent damage due to jet blast or ingestion of foreign objects into the engine. Further, the thrust level may be varied based on environmental conditions or steering angle. Therefore the maximum throttle level corresponding to the maximum impetus level may be a fraction of the maximum possible throttle level of the aircraft 18. Hence, in this embodiment of the invention the maximum throttle level is 40% of the possible throttle level range of the aircraft 18. However, in other embodiments of the invention the maximum throttle level may be a different percentage of the possible throttle level of the aircraft.

In FIG. 4, the pilot 10 applies a deflection pressure 420 to the active side stick 14 (which started in a neutral position) resulting in a full backward deflection. The angle of rotation 422 that is measured therefore changes from 0° about the first axis to a maximum negative angle (−max°). The controller 16 then generates a control signal 424 comprising a brake level and transmits the control signal 424 to the aircraft 18. The brake level causes a brake action involving the brake application level changing from no braking to a maximum brake application level in accordance with the measured angle of rotation 422. The brake action may be carried out with respect to the actual brake pedals of the aircraft 18.

The maximum brake application level may not be a maximum possible brake application level and may instead correspond to a maximum brake level forming part of the control signal 424. The maximum brake level may be limited such that a deceleration of the aircraft 18 does not exceed a predetermined maximum deceleration value. Therefore, the maximum brake application level corresponding to the maximum brake level may be a fraction of the maximum possible brake application level of the aircraft 18. However, if the deflection pressure 420 exceeds a predetermined pressure value and the pressure direction is negative, the controller may increase the maximum brake level such that there is no limit to the deceleration of the aircraft 18.

Also in CS1, the target steering angle is representative of a nose wheel angle.

FIG. 5 demonstrates how steering control may be performed by the pilot 10 according to CS1. In this example, the pilot 10 applies a deflection pressure 520 to the active side stick 14 (which started in a neutral position) resulting in a full right deflection. The angle of rotation 522 that is measured therefore changes from 0° to a maximum positive angle (+max°) about the second axis. The controller 16 then generates a control signal 524 comprising a target steering angle and transmits the control signal 524 to the aircraft 18. The target steering angle causes a nose wheel action involving the nose wheel angle changing from 0° to a maximum steering angle in the right (positive) direction in accordance with the measured angle of rotation 522. In this embodiment the maximum steering angle is 75°, but the maximum steering angle may be any suitable angle. Additionally, the control signal may be generated such that it further comprises a differential thrust/brake level once the target steering angle exceeds a predetermined steering value (70° for example).

Another aspect of CS1 is that, if there is no deflection pressure applied to the active side stick, the active side stick returns to a neutral position such that the angles of rotation about the first axis and the second axis are 0.

Referring now to FIG. 6, the pilot 10 releases the active side stick such that the deflection pressure 620 reduces to 0 in all directions. In accordance with CS1 the active side stick returns to the neutral position. Therefore the angle of rotation 622 that is measured changes from the last angle of rotation measured when a deflection pressure was being applied to the active side stick (X°, Y°) to 0° about both the first and second axes (0°, 0°). The controller 16 then generates a control signal 624 comprising an impetus level, a brake level and a target steering angle and transmits the control signal 624 to the aircraft 18. The impetus level, brake level and target steering angle cause the throttle level, brake application level and the nose wheel angle respectively to each go to 0 in accordance with the measured angle of rotation 622 (wherein a throttle level of 0 corresponds to idle thrust). The aircraft 18 therefore enters an idle condition in which the aircraft 18 may coast to a gradual stop while travelling in a straight line (if the aircraft is not already stationary).

CS2 is similar to CS1 except that, if there is no deflection pressure applied to the active side stick, the active side stick maintains its current position rather than returning to a neutral position. This means that the angles of rotation about the first axis and the second axis stay constant with respect to the last angles of rotation measured when a deflection pressure was being applied to the active side stick.

FIG. 7 shows the same control action being applied by the pilot 10 as in FIG. 6. However, in this example CS2 is applied rather than CS1. Therefore, when the pilot 10 releases the active side stick, the angle of rotation 722 that is measured remains constant at the angle of rotation measured when a deflection pressure was last being applied by the pilot 10 (X°, Y°). This means that the controller 16 generates a control signal 724 wherein the impetus level, brake level and target steering angle each remain constant. The aircraft 18 receives the control signal 724 and the throttle level, brake application level and nose wheel angle are each caused to remain constant. This means that the pilot 10 may momentarily release the active side stick 14 to perform another action and aircraft 18 will continue as if there has been no change to the controls applied by the pilot 10.

In CS3 the impetus and brake levels are representative of a target speed for the aircraft to reach. The control signal may be generated such that if the angle of rotation of the active side stick about the first axis is 0° the throttle action and brake action caused are to set the throttle level and the brake application level respectively to achieve an actual speed value of 0 km/h and if the angle of rotation of the active side stick about the first axis is a maximum angle the throttle action and brake action caused are to set the throttle level and the brake application level respectively to achieve an actual speed value equal to a maximum allowable speed.

FIG. 8 shows an example of a control that may be implemented according to CS3. The pilot 10 applies a deflection pressure 820 to the active side stick 14 (which started in a neutral position) resulting in a full forward deflection. The angle of rotation 822 that is measured therefore changes from 0° about the first axis to a maximum positive angle (+max°). The controller 16 then generates a control signal 824 comprising a impetus/brake level representative of a target speed and transmits the control signal 524 to the aircraft 18. The impetus/brake level causes throttle/brake actions wherein the throttle level and brake level are set in order to achieve the speed changing from 0 km/h to a maximum allowable speed (max km/h) in accordance with the measured angle of rotation 822. The throttle and brake actions may be carried out with respect to the actual throttle levers and brake pedals of the aircraft 18. For example, the braking applied may be reduced so that no braking occurs, and the throttle levers may be increased to a maximum amount until the target speed is reached. The throttle levers may then be adjusted to maintain the speed, rather than increase it further, beyond the maximum allowable speed. The throttle level and brake application level required may be calculated according to any suitable control technique, such as PID control or fuzzy logic.

An advantage of CS3 is that the pilot is simply required to set the speed of the aircraft by deflecting the active side stick and may allow the controller to generate the required throttle and braking levels required to achieve the speed. This reduces the requirement of the pilot to adjust controls based on external disturbances (such as gradient and wind speed) and therefore simplifies operation of the aircraft when taxiing.

According to CS3, the target steering angle is representative of a target angle for a nose wheel, similarly to CS1 and CS2. Therefore the pilot may implement steering control similarly to the example shown in FIG. 5, described above.

CS3 is also similar to CS1 in that if there is no deflection pressure applied to the active side stick, the active side stick returns to a neutral position such that the angles of rotation about the first axis and the second axis are 0. However, as the impetus/brake levels are representative of a target speed, the effect of the pilot releasing the active side stick is different for CS3 when compared to CS1. FIG. 9 shows that when the pilot 10 releases the active side stick and the measured angle of rotation 922 changes to (0°, 0°) the target speed changes to 0 km/h (provided it was not already 0 km/h), as well as the target steering angle changing to 0° in accordance with CS1 and FIG. 6. This means that, rather than the aircraft 18 entering an idle condition, the aircraft 18 is caused to apply the brakes (via a brake application level) in order to reduce the speed to 0 km/h (although the braking may be limited to a maximum brake level in order to limit deceleration). This control strategy may reduce the risk of the aircraft being involved in an accident if the pilot is distracted or otherwise unable to control the aircraft.

CS4 is similar to CS3 except that, if there is no deflection pressure applied to the active side stick, the active side stick maintains its current position rather than returning to a neutral position. This means that the angles of rotation about the first axis and the second axis stay constant with respect to the last angles of rotation measured when a deflection pressure was being applied to the active side stick. In this aspect of the control strategy, CS4 is similar to CS2 and is therefore similarly represented by FIG. 7 in which the control signal 724 remains constant when the active side stick 14 is released by the pilot 10.

However, in this case rather than specific throttle/brake levels remaining constant, it is the target speed of the aircraft that remains constant. Therefore, when the pilot releases the active side stick and a constant target speed is set, the controller 16 may adjust impetus and brake levels in order to ensure that the speed of the aircraft is maintained at the desired target speed. Factors such as taxiway gradient and wind speed may affect the actual speed of the aircraft and this may be fed back to the controller as part of an aircraft signal, hence allowing the controller to adjust the generated control signal accordingly.

In CS5 the impetus level is representative of a target acceleration such that if the angle of rotation of the active side stick about the first axis is 0 the throttle action caused is to set the throttle level to achieve an acceleration of 0 m/s² and if the angle of rotation of the active side stick about the first axis is a maximum positive angle the throttle action caused is to set the throttle level to achieve a maximum acceleration. Similarly, the brake level is representative of a target deceleration such that if the angle of rotation of the active side stick about the first axis is 0 the brake action caused is to set the brake application level to achieve a deceleration of 0 m/s² and if the angle of rotation of the active side stick about the first axis is a maximum negative angle the brake action caused is to set the brake application level to achieve a maximum deceleration, which may be a predetermined value such as 1.5 m/s².

FIGS. 10 and 11 show the controls that may be implemented according to CS5. In particular, in FIG. 10 the pilot 10 applies a deflection pressure 1020 to the active side stick 14 (which started in a neutral position) resulting in a full forward deflection. The angle of rotation 1022 that is measured therefore changes from 0° about the first axis to a maximum positive angle (+max°). The controller 16 then generates a control signal 1024 comprising an impetus level representative of target acceleration and transmits the control signal 1024 to the aircraft 18. The impetus level causes a throttle action wherein the throttle level is set in order that the acceleration of the aircraft 18 changes from 0 m/s² to a maximum acceleration (max m/s²) in accordance with the measured angle of rotation 1022. The throttle action may be carried out with respect to the actual throttle levers of the aircraft in order to achieve the target acceleration forming part of the control signal 1024.

Similarly, in FIG. 11, the pilot 10 applies a deflection pressure 1120 to the active side stick 14 (which started in a neutral position) resulting in a full backward deflection. The angle of rotation 1122 that is measured therefore changes from 0° about the first axis to a maximum negative angle (−max°). The controller 16 then generates a control signal 1124 comprising a brake level representative of a target deceleration and transmits the control signal 1124 to the aircraft 18. The brake level causes a brake action wherein the brake application level is set in order that the deceleration of the aircraft changes from 0 m/s² to a maximum deceleration (max m/s²) in accordance with the measured angle of rotation 1122. The brake action may be carried out with respect to the actual brake pedals of the aircraft in order to achieve the target deceleration forming part of the control signal 1124.

Further, the maximum deceleration may be limited such that the deceleration of the aircraft 18 does not exceed a predetermined maximum deceleration value. Therefore, the maximum deceleration may not be the maximum possible braking achievable by the aircraft 18. However, if the deflection pressure 1120 exceeds a predetermined pressure value, the controller may increase the maximum deceleration such that there is no limit to the deceleration of the aircraft 18.

Also in CS5, the target steering angle is representative of a steering angle rate, that is the rate at which the angle of the aircraft's nose wheel is changed.

FIG. 12 demonstrates how steering control may be performed by the pilot 10 according to CS5. In this example, the pilot 10 applies a deflection pressure 1220 to the active side stick 14 (which started in a neutral position) resulting in a full right deflection. The angle of rotation 1222 that is measured therefore changes from 0° to a maximum positive angle (+max°) about the second axis. The controller 16 then generates a control signal 1224 comprising a target steering angle representative of a steering angle rate and transmits the control signal 1224 to the aircraft 18. The target steering angle causes a nose wheel action wherein the steering angle rate is set such that it changes from 0°/s to a maximum steering angle rate (+max °/s) in the right (positive) direction in accordance with the measured angle of rotation 1222. Additionally, if the steering angle exceeds a predetermined steering value (±70° for example), the control signal may be generated such that it further comprises a differential thrust/brake level. The differential thrust/brake level may be increased from zero to a maximum level as the steering angle increases from the predetermined steering value to a maximum possible angle (e.g. 700 to 750).

Another aspect of CS5 is that, similarly to CS1 and CS3, the active side stick returns to a neutral position if there is no deflection pressure applied to the active side stick.

However, as the impetus/brake levels are representative of a target acceleration or deceleration, the effect of the pilot releasing the active side stick is different for CS5 when compared to CS1 or CS3. FIG. 13 shows that when the pilot 10 releases the active side stick and the measured angle of rotation 1322 changes to (0°, 0°) the target acceleration/deceleration changes to 0 m/s² (provided it was not already 0 m/s²). In other words, the aircraft maintains a constant speed if the active side stick is released.

A further difference to CS1 and CS3 is that the target steering angle is representative of a steering angle rate. Therefore when the pilot 10 releases the active side stick and the measured angle of rotation 1322 changes to (0°, 0°) the steering angle rate changes to 0°/s (provided it was not already 0°/s). In other words, the aircraft maintains the steering angle that was set before the pilot released the active side stick.

Control of an aircraft while taxiing may substantially involve maintaining a constant speed in a straight line or while performing a turn with a constant steering angle. CS5 may therefore be advantageous as the pilot is only required to deflect the active side stick in order to change the speed and/or steering angle of the aircraft. When the pilot wants the aircraft to maintain its current course and speed there is no requirement to deflect the active side stick from its neutral position.

Control strategies 1 to 5 represent examples of how different features of the invention may be combined to define particular embodiments of the invention. Other embodiments of the invention may comprise any suitable combination of the features described above. For example, some embodiments of the invention may combine the throttle/brake level features of CS1 with the steering angle rate features of CS5.

Referring now to FIG. 14, an aircraft taxiing system is generally defined by the reference numeral 1402 and comprises a pilot (not shown), an active side stick 1414, a controller 1416 and an aircraft 1418. The active side stick 1414 and the controller 1416 form part of a control system which may carry out a method according to an embodiment of the invention configured according to CS3 and wherein the control signal is generated according to fuzzy logic. (FIG. 14 refers to speed control, but it is to be understood that this is for the purpose of demonstration and that embodiments of the invention are not limited to speed control only.) In this example, the active side stick 1414 is deflected by the pilot and an angle of rotation 1422 about the first axis is measured. The angle of rotation 1422 is transmitted to the controller 1416. The controller 1416 then translates the angle of rotation 1422 to the target speed that it is representative of in accordance with CS3. Simultaneously the controller 1416 receives a first aircraft signal 1430a which is representative of the actual acceleration of the aircraft 1418 and a second aircraft signal 1430b which is representative of the actual speed of the aircraft 1418. The controller 1416 may then generate a control signal based on the aircraft signals 1430a, 1430b and the angle of rotation 1422 of the active side stick 1414.

In this particular example, the controller 1416 calculates a velocity error 1440 based on the difference between the target speed set by the angle of rotation 1422 and the actual speed represented in the second aircraft signal 1430b. The controller 1416 then determines inputs 1442 for a fuzzy logic control algorithm based on the first aircraft signal 1430a and the velocity error 1440.

Table 3 comprises examples of fuzzy sets corresponding to acceleration and FIG. 15 shows a graphical representation of the membership function corresponding to each fuzzy set.

TABLE 3

| Fuzzy set | | Acceleration (A) |
|---|---|---|
| NA | Negative acceleration | −3 m/s² ≤ A ≤ −1.5 m/s² |
| ZA | Zero acceleration | −2 m/s² ≤ A ≤ 2 m/s² |
| PA | Positive acceleration | 1.5 m/s² ≤ A ≤ 3 m/s² |

For example, if the first aircraft signal 1430a is representative of an actual acceleration of 3 m/s² the controller would determine that the acceleration value belongs to fuzzy set PA (positive acceleration). It is also possible for an acceleration value to belong to multiple fuzzy sets. For instance, if the first aircraft signal 1430a is representative of an actual acceleration of 1.8 m/s² the controller would determine that the acceleration value belongs to fuzzy sets PA (positive acceleration) and ZA (zero acceleration).

Table 4 comprises examples of fuzzy sets corresponding to velocity error and FIG. 16 shows a graphical representation of the membership function corresponding to each fuzzy set.

TABLE 4

| Fuzzy set | | Velocity error (Ve) |
|---|---|---|
| NE | Negative error | −50 kts ≤ Ve ≤ −9 kts |
| | | (−92.6 km/h ≤ Ve ≤ −16.7 km/h) |
| NZE | Negative-Zero error | −10 kts ≤ Ve ≤ 0 kts |
| | | (−18.5 km/h ≤ Ve ≤ 0 km/h) |
| ZE | Zero error | −0.3 kts ≤ Ve ≤ 3 kts |
| | | (−0.556 km/h ≤ Ve ≤ 5.56 km/h) |
| PZE | Positive-Zero error | 2 kts ≤ Ve ≤ 10 kts |
| | | (3.70 km/h ≤ Ve ≤ 18.5 km/h) |
| PE | Positive error | 9 kts ≤ Ve ≤ 50 kts |
| | | (16.7 km/h ≤ Ve ≤ 92.6 km/h) |

For example, if the velocity error 140 is −20 kts (−37.0 km/h) the controller would determine that the velocity error belongs to fuzzy set NE (negative error). It is also possible for a velocity error value to belong to multiple fuzzy sets. For instance, if the velocity error 1440 is 2.5 kts (4.63 km/h) the controller would determine a fuzzified input of ZE (zero error) and PZE (positive zero-error).

The controller comprises a fuzzy logic controller 1417 which is configured to determine an output 144 based on an input 1442. The behaviour of the fuzzy logic controller 1417 may be established through a set of fuzzy rules which are based on ‘if then’ conditions. Table 5 provides an example for a set of rules for the fuzzy logic controller 1417 to follow based on inputs 1442 determined in relation to velocity error and acceleration.

TABLE 5

| | Velocity | | Throttle | Brakes |
|---|---|---|---|---|
| Rule # | Error | Acceleration | Command | Command |
| 1 | PE | PA | Medium | Zero |
| 2 | PE | ZA | High | Zero |
| 3 | PE | NA | High | Zero |
| 4 | PZE | PA | Low | Zero |
| 5 | PZE | ZA | Medium | Zero |
| 6 | PZE | NA | Medium | Zero |
| 7 | ZE | PA | Zero | Low |
| 8 | ZE | ZA | Zero | Zero |
| 9 | ZE | NA | Low | Zero |
| 10 | NZE | PA | Zero | Medium |
| 11 | NZE | ZA | Zero | Low |
| 12 | NZE | NA | Zero | Low |
| 13 | NE | PA | Zero | High |
| 14 | NE | ZA | Zero | Medium |
| 15 | NE | NA | Zero | Medium |

In this example the outputs 1444 are determined in relation to throttle and brake commands.

The basic logic behind the rules defined in Table 5 is the following:
If the actual speed is lower than the target speed, then the velocity error is positive (PE/PZE) and the aircraft needs to speed up. This is achieved by increasing the throttle and/or reducing brake pressure, especially if the velocity error is large (PE) and the aircraft is slowing down (NA).
If the actual speed is greater than the target speed, then the velocity error is negative (NE/NZE) and the aircraft needs to slow down. This is achieved by reducing the throttle and/or increasing brake pressure, especially if the velocity error is large (NE) and the aircraft is speeding up (PA).
If the actual speed is close to the target speed, then the velocity error is small (ZE) and the aircraft either needs to speed up or slow down a small amount (relative to the two cases described above). This is achieved by applying very small throttle and/or brake commands.
The brake command is zero whenever the throttle command is non-zero (and vice-versa).

For instance, Rule 2 states that, if the velocity error is positive (PE) and the acceleration is zero (ZA), then the throttle command should be high while the brake command should be zero.

Since both the velocity error and the acceleration can belong to multiple fuzzy sets, multiple fuzzy rules may be activated at the same time (to different degrees). For instance, if the velocity error is 20 knots (and therefore belongs to fuzzy set PE) and the acceleration is 1.7 m/s2 (and therefore belongs to fuzzy sets ZA and PA), then fuzzy rules 1 and 2 are activated simultaneously.

In order for the controller 1416 to generate a control signal with exact numerical values for, in this example, the throttle level and brake application level the throttle and brake commands must undergo defuzzification.

Table 6 comprises examples of fuzzy sets corresponding to throttle command and FIG. 17 shows a graphical representation of the membership function corresponding to each fuzzy set.

TABLE 6

| Fuzzy set | Throttle command (T_{cmd}) |
|---|---|
| Zero | Tcmd = 0 |
| Low | 0 ≤ Tcmd ≤ 0.17 |
| Medium | 0.15 ≤ Tcmd ≤ 0.25 |
| High | 0.23 ≤ Tcmd ≤ 0.40 |

For example, if the velocity error and acceleration are determined to belong to fuzzy sets PE and ZA respectively then, according to Rule 2, the fuzzified output relating to throttle command would be “High”. Therefore the fuzzy logic controller 1417 would determine a throttle level in the range of 0.23 to 0.40.

The exact throttle level is determined by applying a defuzzification method which combines the fuzzy outputs of all of the rules that are activated simultaneously in order to produce a single crisp value.

Table 7 comprises examples of fuzzy sets corresponding to brake command and FIG. 18 shows a graphical representation of the membership function corresponding to each fuzzy set.

TABLE 7

| Fuzzy set | Brake command (B_{cmd}) |
|---|---|
| Zero | Bcmd = 0 |
| Low | 0. ≤ Bcmd ≤ 0.4 |
| Medium | 0.35 ≤ Bcmd ≤ 0.75 |
| High | 0.70 ≤ Bcmd ≤ 1.0 |

For example, if the velocity error and acceleration are determined to belong to fuzzy sets NZE and PA respectively then, according to Rule 10, the fuzzified output relating to brake command would be “Medium”. Therefore, the fuzzy logic controller 1417 would determine a brake level in the range 0.35 and 0.75.

The crisp throttle and brake command values are generated, as set out above, as outputs 1444 from the fuzzy logic controller 1417. The controller 1416 then generates a first control signal 1424a based on the throttle command and a second control signal 1424b based on the brake command. Each of the control signals 1424a, 1424b are transmitted to the aircraft 1418 in order to cause a throttle action and a brake action respectively.

To demonstrate the result of an aircraft's speed being controlled according to the embodiment of the invention described above, FIG. 19 shows a graphical representation of the actual speed of the aircraft varying based on the target speed set by the pilot by deflecting the active side stick. FIG. 20, then shows the associated throttle actions and brake actions caused by the controller over the same period of time shown in FIG. 19.

Referring now to FIG. 21, steps forming part of a method according to an embodiment of the invention are represented. In this embodiment of the invention the aircraft signal 2130 comprises a position of the aircraft on the taxiway. The controller 16 may determine a required state of the aircraft, i.e. the required position of the aircraft on the taxiway—the centreline. The controller 16 may then calculate a cross-track error, which is representative of the shortest distance between the position of the aircraft 18 on a taxiway and a centreline of the taxiway.

It is beneficial for an aircraft to remain as close as possible to the centreline of the taxiway it is travelling along as this reduces the risk of the aircraft leaving the taxiway which can result in damage to the aircraft. However, it can be difficult for a pilot to gauge how accurately the aircraft is following the centreline, particularly during a turn.

To assist with reducing the cross-track error, this embodiment of the invention further involves generating a user feedback signal 2132 such that the magnitude of a user feedback action 2134 to be carried out by the active side stick 14 is proportional to the cross-track error. The active side stick 14 receives the user feedback signal 2132 and carries out the user feedback action 2134 accordingly, thereby providing feedback to the pilot 10.

As the user feedback action 2134 is proportional to the cross-track error, the user feedback action 2134 indicates the degree of cross-track error to the pilot 10 to allow the pilot to make the necessary corrections to the aircraft's steering. For example, the user feedback action 2134 may be a vibration that becomes more intense (for example by increasing the amplitude and/or the frequency of the vibration) as the cross-track error increases. Alternatively, the user feedback action 2134 may be a pressure or force bias applied to the pilot's hand via the active side stick 14 in the direction opposite to the direction of the cross-track error, therefore prompting the pilot to correct the active side stick's positioning.

FIG. 22 shows a graphical representation of a user feedback action (in the form of a force bias applied to the pilot's hand through the active side stick) being carried out in response to varying magnitude and direction of a cross track error.

The listing or discussion of an apparently prior-published document in this specification should not necessarily be taken as an acknowledgement that the document is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention. For example, some embodiments of the invention may combine disclosed features of the invention in different configurations to those which are given as examples in Table 2.

1. A method for controlling an aircraft when taxiing comprising the steps of:
measuring an angle of rotation of an active side stick about a first axis and a second axis;
receiving an aircraft signal representative of an actual state of the aircraft;
generating a control signal based on at least one of: the aircraft signal and the angle of rotation of the active side stick about a first axis and a second axis;
transmitting the control signal to the aircraft, whereby the control signal causes an action affecting the actual state of the aircraft;
determining a required state of the aircraft;
generating a user feedback signal based on at least one difference between the actual state and the required state; and
carrying out a user feedback action based on the user feedback signal.

2. The method according to claim 1 wherein the user feedback signal is generated such that the magnitude of the user feedback action is proportional to a difference between the actual state and the required state.

3. The method according to claim 1 wherein a difference between the actual state and the required state is a cross-track error representative of the shortest distance between an aircraft position on a taxiway and a centreline of the taxiway.

4. The method according to claim 1 further comprising the step of receiving a disabling signal and disabling the user feedback action from being carried out for a period of time.

5. The method according to claim 1 wherein the control signal comprises an impetus level and a brake level, each based on the angle of rotation of the active side stick about the first axis.

6. The method according to claim 5 comprising the further step of limiting the brake level to a maximum brake level such that a deceleration of the aircraft does not exceed a predetermined maximum deceleration value.

7. (canceled)

8. The method according to claim 5 wherein the aircraft signal further comprises an actual speed value and the method comprises the further steps of:
limiting the impetus level to a maximum impetus level; and
if the actual speed value is exceeding a maximum allowable speed, reducing the maximum impetus level.

9-11. (canceled)

12. The method according to a claim 1 wherein the control signal comprises a target steering angle based on the angle of rotation of the active side stick about the second axis.

13. The method according to claim 12 further comprises the step of determining an asymmetric thrust compensation factor, wherein the target steering angle is additionally based on the asymmetric thrust compensation factor.

14. The method according to claim 12 wherein if the target steering angle exceeds a predetermined steering value, the control signal is generated such that it further comprises a differential thrust/brake level.

15. The method according to claim 12 wherein the aircraft signal comprises an actual speed value and the method comprises the further steps of:
limiting the target steering angle to a maximum target steering angle; and
varying the maximum target steering angle based on the actual speed value.

16. The method according to claim 5 wherein the impetus level causes a throttle action affecting the actual state of the aircraft and the brake level causes a brake action affecting the actual state of the aircraft.

17. The method according to claim 16 wherein the control signal is generated such that if the angle of rotation of the active side stick about the first axis is less than or equal to 0° the throttle action caused is to set a throttle level to idle and if the angle of rotation of the active side stick about the first axis is a maximum positive angle the throttle action caused is to set the throttle level corresponding to the maximum impetus level.

18. The method according to claim 16 wherein the control signal is generated such that if the angle of rotation of the active side stick about the first axis is greater than or equal to 0° the brake action caused is to set a brake application level to none and if the angle of rotation of the active side stick about the first axis is a maximum negative angle the brake action caused is to set the brake application level corresponding to the maximum brake level.

19-21. (canceled)

22. The method according to claim 12 wherein the target steering angle causes a nose wheel action.

23-24. (canceled)

25. The method according to claim 1 comprising the further step of returning the active side stick to a neutral position such that the angles of rotation about the first axis and the second axis are 0 if there is no deflection pressure applied to the active side stick.

26. The method according to claim 1 comprising the further step of holding the active side stick in its current position such that the angles of rotation about the first axis and the second axis stay constant if there is no deflection pressure applied to the active side stick.

27. The method according to claim 1 wherein the step of generating a control signal comprises the step of using a control algorithm and optionally the control algorithm is a PID control algorithm or a fuzzy logic control algorithm.

28. The method according to claim 27 wherein the step of generating a control signal using a fuzzy logic control algorithm comprises the steps of:
determining a fuzzified input based on one or both of the angle of rotation of the active side stick about the first axis and the second axis and the aircraft signal,
determining a fuzzified output based on the fuzzified input and a set of fuzzy rules,
determining a de-fuzzified output based on the fuzzified output wherein the control signal is representative of the de-fuzzified output.

29. The system for controlling an aircraft when taxiing configured to carry out a method according to claim 1.
